(19) United States
(12) Patent Application Publication
(10) Pub. No.: US 2011/0036429 A1
(43) Pub. Date: Feb. 17, 2011

(54) Valve Body, Valve Having Such a Body, Device for Mixing Component Parts of a Composition, and Use of Such a Mixing Device

(75) Inventor: Patrice Griffaton, Saint Jean Le Blanc (FR)

Correspondence Address: MILLER, MATTHIAS & HULL, ONE NORTH FRANKLIN STREET, SUITE 2350, CHICAGO, IL, 60606, US

(73) Assignee: PARFUMS CHRISTIAN DIOR, Paris (FR)

(21) Appl. No.: 12/988,195

(22) PCT Filed: Apr. 15, 2009
(86) PCT No.: PCT/FR2009/050697

§ 371 Date: Oct. 15, 2010

(30) Foreign Application Priority Data
Apr. 16, 2008 (FR) 0852582

(51) Int. Cl. F15D 1/00; F16K 51/00

(52) U.S. Cl. 137/565.23; 251/366

(57) ABSTRACT

Valve body comprising a seat designed to be closed off by a shutter, a main duct extending along a first axis and passing through the seat, and a secondary duct opening into the main duct at a junction and extending along a second axis that is not parallel to the first axis. The secondary duct comprises a restriction at the junction between the said secondary duct and the said main duct.

The present invention relates to a valve body comprising:
a seat designed to be shut off by a shutter,
a main duct extending along a first axis and passing through said seat, and
a secondary duct opening into the main duct at a junction and extending along a second axis not parallel to the first axis.

The invention also relates to a valve having such a valve body, to a device for mixing the constituent ingredients of a composition comprising such a valve, and to the use of such a mixing device for producing cosmetic, pharmaceutical or agrifoodstuffs products.

In a known way, certain stages in the manufacture of compositions, such as cosmetic, pharmaceutical, agrifoodstuffs, chemical, etc. products entail the mixing of constituent ingredients and, commonly, the prior introduction of a fluid which may be a liquid and/or a solid in another fluid of the liquid type and/or may be a solid in a phase of agitation, into a mixing vessel.

In the frequently encountered scenario where solid substances are being introduced into a liquid, these substances are incorporated in the form of granules or powders by vacuum suction. To do this, a valve that can be used to regulate the opening and closing of the mixing vessel connects the latter to a reservoir containing the granules (or the powder).

A solid substance is introduced by maintaining a vacuum in the vessel so that the granules (or the powder) pass (passes) through the valve without the fluid, generally a liquid, present in the vessel escaping therefrom. The opening and closing of the vessel so that solid substances can be introduced is therefore performed using a valve which has a valve body having a seat designed to be alternately opened and shut off by a shutter, generally actuated using pneumatic means.

However, in known valves, the numerous openings/closings of the valve leads to a build up of granules or powder in the valve body and this build up has a tendency to jam the valve, preventing the seat of the valve body from being completely shut off and/or preventing correct sealing from being achieved at the seal upon closure. It therefore follows that the seat of the valve body is not completely shut off and/or sealed and that the liquid contained in the mixing vessel flows into the valve body (under a suction effect due to the vacuum present in the vessel) and forms undesirable lumps in the end product. This incident may lead to a loss of the composition that is being prepared, and this has disastrous consequences on the industrial manufacture while at the same time also entailing significant plant maintenance.

Specifically, in order to avoid this build up of substance in the valve body and, in particular, on the seals situated on the shutter, it is known practice for the seals to be changed, and for this to be done up to two or three times per day, and for the valve body to be cleaned. This changing of the seals leads to a systematic halt in production, but also carries a mechanical risk and a risk of reducing the quality of what is being produced.

This kind of problem is common to the cosmetic, pharmaceutical and agrifoodstuffs industries, all of which use this principle of the introduction of fluid under vacuum, particularly in the bottom of the vessel.

It is an object of the invention to provide a valve body which retains all the advantages of the principle of introducing fluid using a vacuum, particularly in the bottom of the vessel, with improved effectiveness of the suction and improved reliability of the sealing with which the valve body is shut off by the shutter upon closure, thus reducing any risk of blockage of the latter.

This object of the invention is achieved through the fact that the secondary duct of the valve body comprises a restriction at the junction between the secondary duct and the main duct.

In various embodiments of the valve body according to the invention, recourse may also possibly be had to one and/or other of the following provisions:
the restriction is delimited by a deflector partially shutting off the secondary duct,
the secondary duct has a bore section upstream of the deflector and said deflector shuts off between 20% and 40% of said bore section,
the shutter is able to move in the valve body between a rest position, in which the seat is open and a shut off position in which the seat is shut off, the deflector being arranged in the secondary duct near the shutter when the latter is in the rest position,
the main duct is delimited by a pipe having an interior surface and the deflector is positioned in the continuation of said interior surface,
the deflector has an end edge which runs in a plane that is radial with respect to the first axis,
the deflector is inclined with respect to the first axis,
the deflector makes, with the first axis, an angle of inclination of less than 20 degrees,
the deflector is a component attached to a main body delimiting at least one of the main and secondary ducts,
the deflector is fixed to said main body by welding,
the first and second axes make between them an angle of between 20 degrees and 70 degrees.

The invention also relates to a valve comprising such a valve body having a moving shutter designed selectively to shut off and to open the seat of the valve body and an actuating mechanism designed to actuate the shutter.

The invention also relates to a device for mixing the constituent ingredients of a composition, comprising such a valve, a mixing vessel and a vacuum pump, said mixing vessel being connected to said vacuum pump and to said valve. The valve is preferably connected to the mixing vessel situated above said valve, the junction between the main duct and the secondary duct being positioned below the seat of the valve body and the secondary duct extending downward from said junction.

The invention also relates to the use of such a mixing device for producing cosmetic, pharmaceutical or agrifoodstuffs products. Said products may in particular be produced in the form of a gel, a cream, a foam, a paste or a lotion.

The invention will be clearly understood and its advantages will become better apparent from reading the detailed description which follows of some embodiments which have been given by way of nonlimiting examples.

The description refers to the attached drawings, in which:

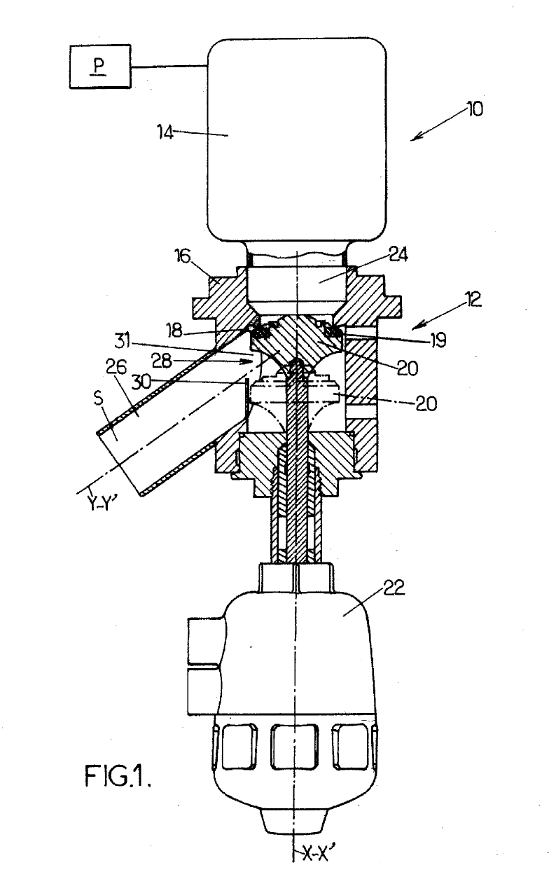

FIG. 1 is a view with partial cutaway illustrating a mixing device according to the invention,

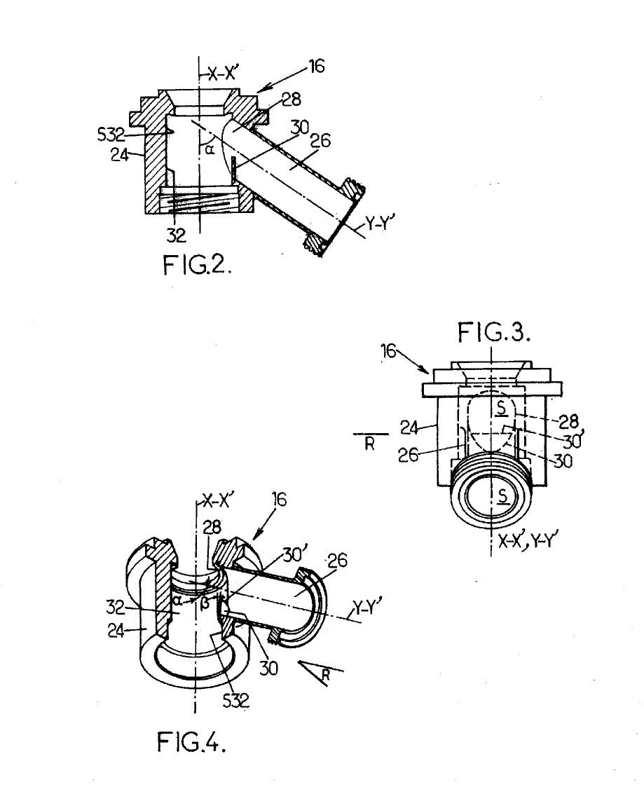

FIG. 2 is a view in longitudinal section of the valve body according to the invention,

FIG. 3 is a side view of the valve body according to the invention, and

FIG. 4 is a perspective view with partial cutaway of just the valve body according to the invention.

FIG. 1 illustrates a mixing device 10 comprising a valve 12 connected to a mixing vessel 14, itself connected to a vacuum pump P which is depicted schematically. In this particular instance, the valve 12 is situated below a mixing vessel 14. The reverse is equally possible. The valve 12 comprises a valve body 16 and an actuating mechanism 22. The valve body 16 comprises a seat 18 that can be shut off by a shutter 20 that can be actuated by an actuating mechanism 22 situated below the valve body 16, on the opposite side to the mixing vessel 14.

The valve body 16 comprises a main duct 24 extending along a first axis X-X′ and passing through the seat 18, and a secondary duct 26 opening into the main duct 24 at a junction 28 dealt with in greater detail later, and extends along a second axis Y-Y′ not parallel to the first axis X-X′, preferably toward the actuating mechanism 22 (in the opposite direction to the mixing vessel 14). In this particular instance, with the mixing vessel 14 arranged above the valve, the secondary duct 26 extends downward in FIG. 1 from the junction 28.

The second axis Y-Y′ of the secondary duct 26 makes with the first axis X-X′ of the main duct 24 an angle preferably of between 20 degrees and 90 degrees, more particularly of between 20 degrees and 70 degrees and, in this particular instance, as illustrated in the figures, advantageously makes an angle α of around 55 degrees.

The shutter is, in the known way, a valve shut-off element of hemispherical shape 20 arranged in the valve body 16, so that it can slide in the main duct 24 along the main axis X-X′ in order selectively to shut off and to open the seat 18 of the valve body 16, which in this particular instance is a straight seat. The actuating mechanism 22 designed to actuate the valve shut-off element 20 is, in the known way, of pneumatic or electrical type.

FIG. 1 illustrates the valve shut-off element 20 using solid line for the shut-off position corresponding to the seat 18 of the valve body 16 being shut off, in which position no fluid flows between the valve 12 and the mixing vessel 14. By contrast, FIG. 1 uses dotted line to illustrate the valve shut-off element 20 in its rest position corresponding to the seat 18 of the valve body 16 being open, in which position the fluid can flow through the valve body 16 toward the mixing vessel 14 in which the vacuum has been created. The shut off position (or raised position of the valve shut-off element 20) is closer to the mixing vessel 14 while the rest position (or lowered position of the valve shut-off element 20) is further away from the mixing vessel 14.

Sealing means, in this instance a seal 19, is arranged on the valve shut-off element 20 to guarantee sealing of the seat 18 of the valve body 16 when the valve shut-off element 20 is shutting off the valve 12.

As better illustrated in FIG. 2, the secondary duct opens into the main duct 24 at a junction 28 positioned below the seat 18 of the valve body 16, this secondary duct 26 extending at an angle, preferably toward the actuating mechanism 22 from this junction 28, so that it can be connected to a reservoir (not illustrated) that contains substances, particularly in the form of granules or powder, intended to be sucked into the mixing vessel 14, particularly under the effect of the vacuum created therein using the vacuum pump P. The junction 28 in fact corresponds to the intersection between the secondary duct 26 and the main duct 24, the secondary duct 26 opening into the main duct 24. In this particular instance, with the mixing vessel 14 situated above the valve 12, the secondary duct 26 extends downward in FIG. 1. At the junction 28, the secondary duct 26 has a restriction 31 delimited by a deflector 30 which partially shuts off the secondary duct 26. This deflector 30 situated in a low down region of the secondary duct 26, namely on the opposite side to the connection between the valve 26 and the mixing vessel 14, allows the secondary duct 26 to be shut off and thus creates turbulence when the fluid flows by suction along said secondary duct 26 toward the main duct 24 on its way to the mixing vessel 14.

Upstream of the deflector 30, that is to say near the reservoir, the secondary duct 26 has a bore section S which is partially shut off by the deflector 30 near the junction 28. In this particular instance, the deflector 30 shuts off between 20 and 40% of the bore section S, and in particular, shuts off around 30%.

The size of the deflector 30 can be chosen so that the latter conceals the valve shut-off element 20 when it is in its open position. In such a case, aside from the turbulence generated in the secondary duct 26 by the deflector 30, the latter prevents fluid from building up upstream of the valve shut-off element 20. It therefore follows that the sealing means and, in particular, the seal 19, have a far longer life and the repeatability of the product series produced using the device is markedly improved. Specifically, it will be understood that because the fluid does not incorrectly remain present in the valve body, the seal 19 guarantees sealed shutting-off of the valve 12 for longer.

The main duct 24 is delimited by a pipe 32 that has an interior surface S32 that is substantially cylindrical about the axis X-X′. In a way that is known for allowing the valve shut-off element 20 to slide in the pipe 32, the dimensions of the valve shut-off element about the axis X-X′ are chosen so that its hemispherical exterior surface is of a size slightly smaller than that of the pipe 32.

However, in order to improve the cleaning of the valve body, the cross section (perpendicular to the axis X-X′) of the exterior surface of the valve shut-off element 20 may be chosen so that it is of a far smaller size in relation to that of the pipe 32. By way of example, a clearance (perpendicular to the axis X-X′) between the exterior surface of the valve shut-off element 20 and the pipe 32 may be of the order of several millimeters, for example of the order of 4 mm to 15 mm, and preferably of the order of 10 mm.

Furthermore, such a clearance between the valve shut-off element 20 and the pipe 32 thus allows the few granules or particles of powder which might nonetheless have built up upstream in the valve body to be sucked toward the mixing vessel 14 at the end of suction.

The deflector 30 is arranged in the continuation of the interior surface 32 so that it extends into the junction 28, as illustrated in FIG. 3. Returning to FIG. 1, the deflector 30 is arranged in the secondary duct 26 near the valve shut-off element 20 when the latter is in its rest position (dotted line). In fact, the deflector 30 is arranged in the secondary duct 26 by being positioned on the opposite side to the mixing vessel 14, on the same side as the actuating mechanism 22.

Referring to FIGS. 3 and 4, the deflector 30 has a free end edge 30′ which extends in a plane R that is radial with respect to the first axis X-X′. With the aforementioned arrangement, the free end edge 30′ is directed toward the mixing vessel 10, away from the actuating mechanism 22.

The deflector 30 is preferably semicylindrical and extends either parallel to the first axis X-X′ or at an angle with respect to said first axis X-X′ toward the inside of the secondary duct 26. When inclined, the deflector 30 makes an angle of inclination β with the first axis X-X′, preferably of less than 20 degrees.

In FIG. 2, the deflector 30 extends parallel to the first axis X-X′, so that the angle of inclination β is zero; contrastingly, in FIG. 4, the deflector 30 is inclined with respect to the first axis X-X′, preferably by an angle of inclination β of the order of 15 degrees.

The deflector 30 may be a component attached to a main body delimiting at least one of the two main 24 and secondary 26 ducts being fixed, preferably by welding, to said main body, the valve body 16 according to the invention comprising said main body and the deflector 30.

The valve 12 according to the invention is particularly well suited to a device for mixing the constituent ingredients of a composition produced from solid substances mixed with liquid substances. By way of example, the powders sucked into the mixing vessel 14 via the valve 12 may be gelling agents, active ingredients, preservatives and mixtures thereof, and the liquid contained in the mixing vessel may be an aqueous phase, an oil phase, to manufacture a gel, a cream, a foam, a paste or a lotion.

The use of such a mixing device 10 according to the invention in particular makes it possible notably to produce cosmetic products that are obtained from a mixture of solid products, in this particular instance, in the form of granules or powder in a liquid.

1. A valve body comprising:
a seat designed to be shut off by a shutter,
a main duct extending along a first axis and passing through said seat, and
a secondary duct opening into the main duct at a junction and extending along a second axis not parallel to the first axis,
characterized in that the secondary duct comprises a restriction at the junction between said secondary duct and said main duct, said restriction is delimited by a deflector partially shutting off the secondary duct, and
in that the shutter is able to move in the valve body between a rest position, in which the seat is open and a shut off position in which the seat is shut off, the deflector being arranged in the secondary duct near the shutter in such a way that it conceals the shutter when the latter is in the rest position.

2. The valve body as claimed in claim 1, in which the secondary duct has a bore section upstream of the deflector and said deflector shuts off between 20% and 40% of said bore section.

3. The valve body as claimed in claim 1, in which the main duct is delimited by a pipe having an interior surface and the deflector is positioned in the continuation of said interior surface.

4. The valve body as claimed in claim 1, in which the deflector is a component attached to a main body delimiting at least one of the main and secondary ducts.

5. The valve body as claimed in the claim, in which the deflector is fixed to said main body by welding.

6. The valve body as claimed in claim 1, in which the first and second axes make between them an angle of between 20 degrees and 70 degrees.

7. The valve body as claimed in claim 1, in which a clearance between the valve shut-off element and the pipe is between 4 mm and 15 mm.

8. A valve comprising a valve body as claimed in claim 1, a moving shutter designed selectively to shut off and to open the seat of the valve body and an actuating mechanism designed to actuate the shutter.

9. A mixing device for mixing the constituent ingredients of a composition, comprising a valve as claimed in claim 8, a mixing vessel and a vacuum pump, said mixing vessel being connected to said vacuum pump and to said valve.

10. The mixing device as claimed in claim 9, in which the valve is connected to the mixing vessel situated above said valve, the junction between the main duct and the secondary duct being positioned below the seat of the valve body and the secondary duct extending downward from said junction.

11. The use of a mixing device as claimed in claim 9 for producing cosmetic, pharmaceutical or agrifoodstuffs products.

12. The use of a mixing device as claimed in claim 11 for producing products in the form of a gel, a cream, a foam, a paste or a lotion

13. The valve body as claimed in claim 2, in which the main duct is delimited by a pipe having an interior surface and the deflector is positioned in the continuation of said interior surface.

14. The valve body as claimed in claim 3, in which the deflector is a component attached to a main body delimiting at least one of the main and secondary ducts.

15. The valve body as claimed in claim 13, in which the deflector is a component attached to a main body delimiting at least one of the main and secondary ducts.

16. A valve comprising a valve body as claimed in claim 2, a moving shutter designed selectively to shut off and to open the seat of the valve body and an actuating mechanism designed to actuate the shutter.

17. A valve comprising a valve body as claimed in claim 3, a moving shutter designed selectively to shut off and to open the seat of the valve body and an actuating mechanism designed to actuate the shutter.

18. A device for mixing the constituent ingredients of a composition, comprising a valve as claimed in claim 16, a mixing vessel and a vacuum pump, said mixing vessel being connected to said vacuum pump and to said valve.

19. The use of a mixing device as claimed in claim 18, for producing cosmetic, pharmaceutical or agrifoodstuffs products.

20. The use of a mixing device as claimed in claim 19, for producing products in the form of a gel, a cream, a foam, a paste or a lotion.
